(19) United States
(12) Patent Application Publication
(10) Pub. No.: US 2016/0277991 A1
(43) Pub. Date: Sep. 22, 2016

(54) LOCATION ID BASED CELL SELECTION METHOD FOR CIRCUIT SWITCHED FALLBACK CALLS

(71) Applicant: QUALCOMM Incorporated, San Diego, CA (US)

(72) Inventors: Ming YANG, San Diego, CA (US); Tom CHIN, San Diego, CA (US); Qingxin CHEN, Del Mar, CA (US)

(21) Appl. No.: 14/735,088

(22) Filed: Jun. 9, 2015

Related U.S. Application Data
(60) Provisional application No. 62/135,623, filed on Mar. 19, 2015.

(51) Int. Cl. H04W 36/32; H04W 36/00; H04W 36/14; H04W 56/00

(52) U.S. Cl. CPC H04W 36/32; H04W 56/001; H04W 36/0083; H04W 36/14

(57) ABSTRACT

A user equipment (UE) collects system information blocks (SIBs) in two phases so the UE can select a target cell to fall back on for a circuit switched fall back (CSFB) call. During the first phase, the UE collects short-period SIBs indicating location IDs for the top N cells corresponding to N strongest frequencies from a frequency list in a redirection command. If the UE finds a cell with a location ID matching the location ID in a previous combined registration, and the synchronization channel quality of the cell exceeds a threshold, the UE selects the cell as the target cell. The UE stops collecting short-period SIBs for other cells. During the second phase, the UE collects mandatory long-period SIBs for the selected target cell only. This reduces potential CSFB call setup latency by avoiding a location area update procedure before circuit switched voice call establishment in a 2G/3G network.

### CROSS REFERENCE TO RELATED APPLICATION

This application claims the benefit under 35 U.S.C. §119(e) to U.S. Provisional Patent Application No. 62/135,623, entitled “LOCATION ID BASED CELL SELECTION METHOD FOR CIRCUIT SWITCHED FALLBACK CALLS,” filed on Mar. 19, 2015, the disclosure of which is expressly incorporated herein by reference in its entirety.

### BACKGROUND

1. Field

Aspects of the present disclosure relate generally to wireless communication systems, and more particularly, to location ID based cell selection for circuit switched fallback (CSFB) calls.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of a telecommunication standard is long term evolution (LTE). LTE is a set of enhancements to the universal mobile telecommunications system (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

According to one aspect of the present disclosure, a method of wireless communication includes determining whether a second radio access technology (RAT) cell corresponding to a frequency on a ranked frequency list of a second radio access technology (RAT) has a location ID that matches a location ID from a previous combined registration of a first RAT and the second RAT when the UE was in a first RAT cell. The location ID is indicated in a decoded short-period system information block (SIB). The method also includes selecting the second RAT cell as a target cell when the second RAT cell has a synchronization channel signal quality above a threshold and the location ID matches a location ID from the combined registration. The method further includes collecting a long-period SIB for the target cell.

According to another aspect of the present disclosure, an apparatus for wireless communication at a user equipment (UE) includes a memory and at least one processor coupled to the memory. The processor(s) is configured to determine whether a second radio access technology (RAT) cell corresponding to a frequency on a ranked frequency list of a second radio access technology (RAT) has a location ID that matches a location ID from a previous combined registration of a first RAT and the second RAT when the UE was in a first RAT cell. The location ID is indicated in a decoded short-period system information block (SIB). The processor(s) is also configured to select the second RAT cell as a target cell when the second RAT cell has a synchronization channel signal quality above a threshold and the location ID matches a location ID from the combined registration. The processor(s) is further configured to collect a long-period SIB for the target cell.

According to another aspect of the present disclosure, an apparatus for wireless communication at a user equipment (UE) includes means for determining whether a second radio access technology (RAT) cell corresponding to a frequency on a ranked frequency list of a second radio access technology (RAT) has a location ID that matches a location ID from a previous combined registration of a first RAT and the second RAT when the UE was in a first RAT cell. The location ID is indicated in a decoded short-period system information block (SIB). The apparatus may also include means for selecting the second RAT cell as a target cell when the second RAT cell has a synchronization channel signal quality above a threshold and the location ID matches a location ID from the combined registration. The apparatus may further include means for collecting a long-period SIB for the target cell.

According to yet another aspect of the present disclosure, a computer program product for wireless communication at a user equipment (UE) includes a non-transitory computer-readable medium having program code recorded thereon. The computer program product includes program code to determine whether a second radio access technology (RAT) cell corresponding to a frequency on a ranked frequency list of a second radio access technology (RAT) has a location ID that matches a location ID from a previous combined registration of a first RAT and the second RAT when the UE was in a first RAT cell. The location ID is indicated in a decoded short-period system information block (SIB). The computer program product also includes program code to elect the second RAT cell as a target cell when the second RAT cell has a synchronization channel signal quality above a threshold and the location ID matches a location ID from the combined registration. The computer program product further includes program code to collect a long-period SIB for the target cell.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a diagram illustrating an example of a network architecture.

FIG. 2 is a diagram illustrating an example of a downlink frame structure in LTE.

FIG. 3 is a diagram illustrating an example of an uplink frame structure in LTE.

FIG. 4 is a block diagram conceptually illustrating an example of a telecommunications system.

FIG. 5 is a block diagram conceptually illustrating an example of a frame structure in a telecommunications system.

FIG. 6 is a block diagram illustrating an example of a global system for mobile communications (GSM) frame structure.

FIG. 7 is a block diagram conceptually illustrating an example of a base station in communication with a user equipment (UE) in a telecommunications system.

FIG. 8 is a diagram illustrating network coverage areas according to aspects of the present disclosure.

FIG. 9 is a call flow diagram conceptually illustrating an example process for a cell selection for circuit switched fallback (CSFB) calls according to aspects of the present disclosure.

FIG. 10 is a flow diagram for obtaining system information for performing an inter-RAT cell reselection or handover according to aspects of the present disclosure.

FIG. 11 is a flow diagram illustrating an example decision process for a location ID based cell selection for CSFB calls according to aspects of the present disclosure.

FIG. 12 is a flow diagram illustrating a method for a location ID based cell selection for CSFB calls at a UE according to aspects of the present disclosure.

FIG. 13 is a block diagram illustrating different modules/means/components for measurements at a UE in an example apparatus according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

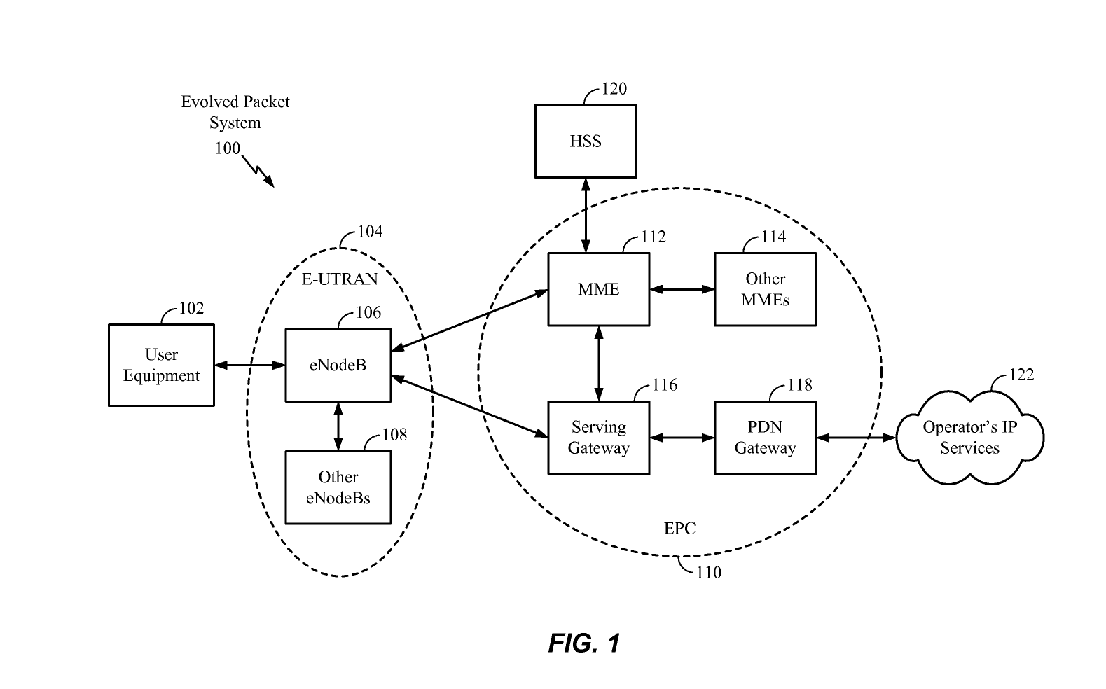

FIG. 1 is a diagram illustrating an LTE network architecture 100. The LTE network architecture 100 may be referred to as an evolved packet system (EPS) 100. The EPS 100 may include one or more user equipment (UE) 102, an evolved UMTS terrestrial radio access network (E-UTRAN) 104, an evolved packet core (EPC) 110, a home subscriber server (HSS) 120, and an operator's IP services 122. The EPS can interconnect with other access networks, but for simplicity those entities/interfaces are not shown. As shown, the EPS 100 provides packet-switched services, however, as those skilled in the art will readily appreciate, the various concepts presented throughout this disclosure may be extended to networks providing circuit switched services.

The E-UTRAN 104 includes an evolved NodeB (eNodeB) 106 and other eNodeBs 108. The eNodeB 106 provides user and control plane protocol terminations toward the UE 102. The eNodeB 106 may be connected to the other eNodeBs 108 via a backhaul (e.g., an X2 interface). The eNodeB 106 may also be referred to as a base station, a base transceiver station, a radio base station, a radio transceiver, a transceiver function, a basic service set (BSS), an extended service set (ESS), or some other suitable terminology. The eNodeB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNodeB 106 is connected to the EPC 110 via, e.g., an 51 interface. The EPC 110 includes a mobility management entity (MME) 112, other MMEs 114, a serving gateway 116, and a packet data network (PDN) gateway 118. The MME 112 is the control node that processes the signaling between the UE 102 and the EPC 110. Generally, the MME 112 provides bearer and connection management. All user IP packets are transferred through the serving gateway 116, which itself is connected to the PDN gateway 118. The PDN gateway 118 provides UE IP address allocation as well as other functions. The PDN gateway 118 is connected to the operator's IP services 122. The operator's IP services 122 may include the Internet, the Intranet, an IP multimedia subsystem (IMS), and a PS streaming service (PSS).

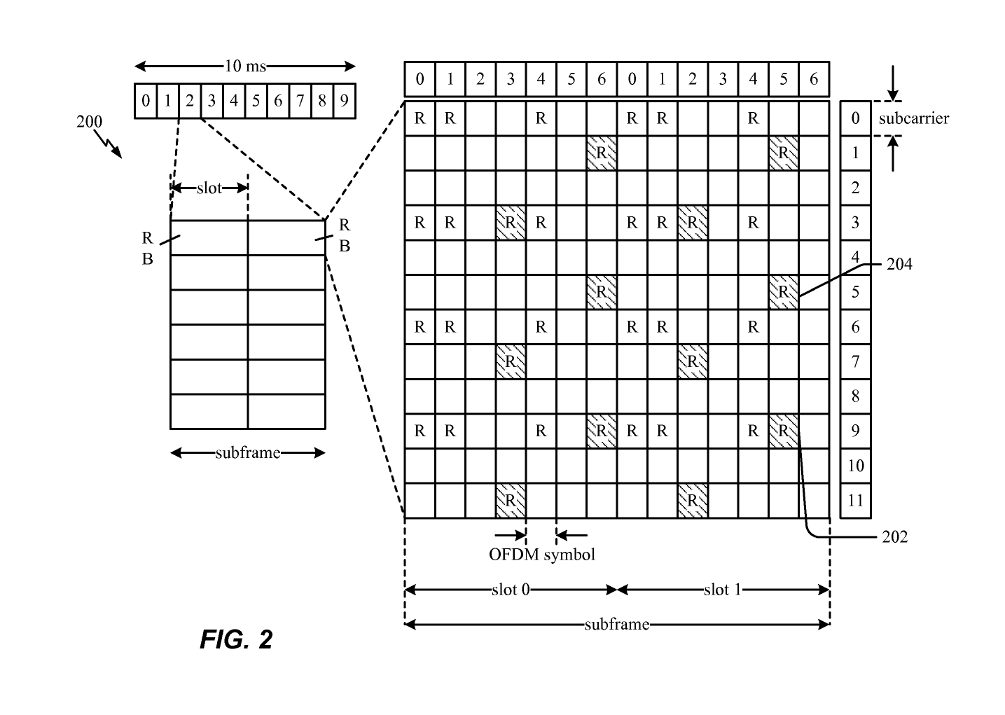

FIG. 2 is a diagram 200 illustrating an example of a downlink frame structure in LTE. A frame (10 ms) may be divided into 10 equally sized subframes. Each subframe may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, as indicated as R 202, 204, include downlink reference signals (DL-RS). The DL-RS include Cell-specific RS (CRS) (also sometimes called common RS) 202 and UE-specific RS (UE-RS) 204. UE-RS 204 are transmitted only on the resource blocks upon which the corresponding physical downlink shared channel (PDSCH) is mapped. The number of bits carried by each resource element depends on the modulation scheme. Thus, the more resource blocks that a UE receives and the higher the modulation scheme, the higher the data rate for the UE.

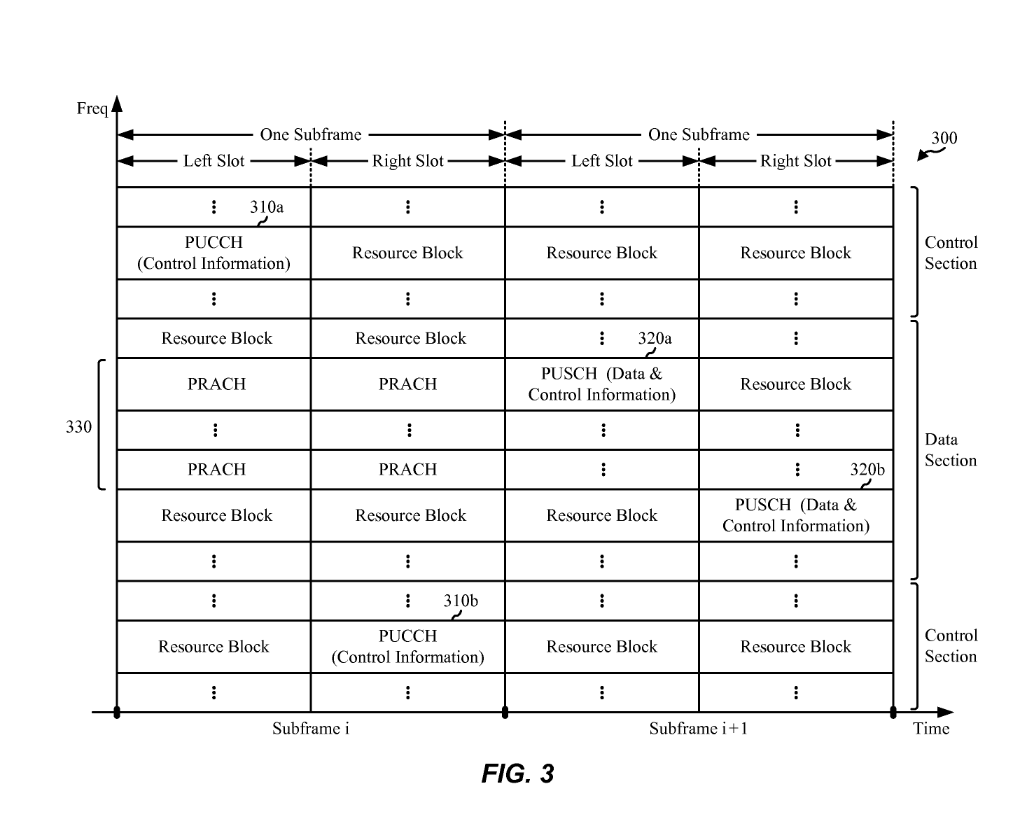

FIG. 3 is a diagram 300 illustrating an example of an uplink frame structure in LTE. The available resource blocks for the uplink may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The uplink frame structure results in the data section including contiguous subcarriers, which may allow a single UE to be assigned all of the contiguous subcarriers in the data section.

A UE may be assigned resource blocks 310a, 310b in the control section to transmit control information to an eNodeB. The UE may also be assigned resource blocks 320a, 320b in the data section to transmit data to the eNodeB. The UE may transmit control information in a physical uplink control channel (PUCCH) on the assigned resource blocks in the control section. The UE may transmit only data or both data and control information in a physical uplink shared channel (PUSCH) on the assigned resource blocks in the data section. An uplink transmission may span both slots of a subframe and may hop across frequency.

A set of resource blocks may be used to perform initial system access and achieve uplink synchronization in a physical random access channel (PRACH) 330. The PRACH 330 carries a random sequence and cannot carry any uplink data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

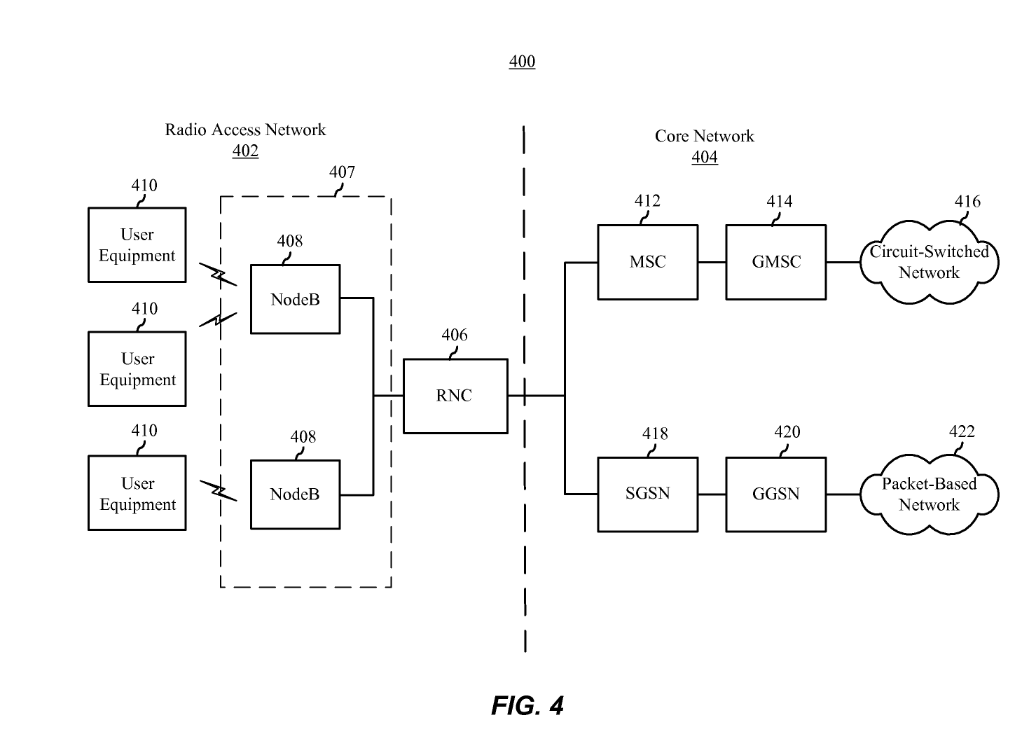

Turning now to FIG. 4, a block diagram is shown illustrating an example of a telecommunications system 400. The various concepts presented throughout this disclosure may be implemented across a broad variety of telecommunication systems, network architectures, and communication standards. By way of example and without limitation, the aspects of the present disclosure illustrated in FIG. 4 are presented with reference to a UMTS system employing a TD-SCDMA standard. In this example, the UMTS system includes a radio access network (RAN) 402 (e.g., UTRAN) that provides various wireless services including telephony, video, data, messaging, broadcasts, and/or other services. The RAN 402 may be divided into a number of radio network subsystems (RNSs) such as an RNS 407, each controlled by a radio network controller (RNC), such as an RNC 406. For clarity, only the RNC 406 and the RNS 407 are shown; however, the RAN 402 may include any number of RNCs and RNSs in addition to the RNC 406 and RNS 407. The RNC 406 is an apparatus responsible for, among other things, assigning, reconfiguring and releasing radio resources within the RNS 407. The RNC 406 may be interconnected to other RNCs (not shown) in the RAN 402 through various types of interfaces such as a direct physical connection, a virtual network, or the like, using any suitable transport network.

The geographic region covered by the RNS 407 may be divided into a number of cells, with a radio transceiver apparatus serving each cell. A radio transceiver apparatus is commonly referred to as a nodeB in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two nodeBs 408 are shown; however, the RNS 407 may include any number of wireless nodeBs. The nodeBs 408 provide wireless access points to a core network 404 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 410 are shown in communication with the nodeBs 408. The downlink (DL), also called the forward link, refers to the communication link from a nodeB to a UE, and the uplink (UL), also called the reverse link, refers to the communication link from a UE to a nodeB.

The core network 404, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 404 supports circuit switched services with a mobile switching center (MSC) 412 and a gateway MSC (GMSC) 414. One or more RNCs, such as the RNC 406, may be connected to the MSC 412. The MSC 412 is an apparatus that controls call setup, call routing, and UE mobility functions. The MSC 412 also includes a visitor location register (VLR) (not shown) that contains subscriber-related information for the duration that a UE is in the coverage area of the MSC 412. The GMSC 414 provides a gateway through the MSC 412 for the UE to access a circuit switched network 416. The GMSC 414 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 414 queries the HLR to determine the UE's location and forwards the call to the particular MSC serving that location.

The core network 404 also supports packet-data services with a serving GPRS support node (SGSN) 418 and a gateway GPRS support node (GGSN) 420. General packet radio service (GPRS) is designed to provide packet-data services at speeds higher than those available with standard GSM circuit switched data services. The GGSN 420 provides a connection for the RAN 402 to a packet-based network 422. The packet-based network 422 may be the Internet, a private data network, or some other suitable packet-based network. The primary function of the GGSN 420 is to provide the UEs 410 with packet-based network connectivity. Data packets are transferred between the GGSN 420 and the UEs 410 through the SGSN 418, which performs primarily the same functions in the packet-based domain as the MSC 412 performs in the circuit switched domain.

The UMTS air interface is a spread spectrum direct-sequence code division multiple access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a nodeB 408 and a UE 410, but divides uplink and downlink transmissions into different time slots in the carrier.

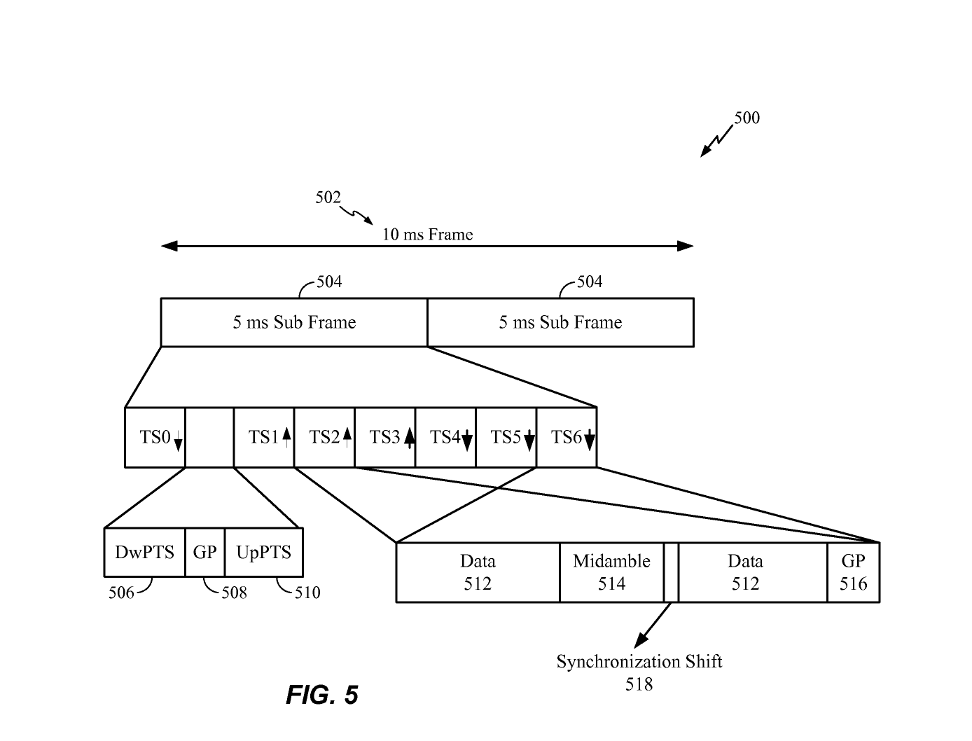

FIG. 5 shows a frame structure 500 for a TD-SCDMA carrier. The TD-SCDMA carrier, as illustrated, has a frame 502 that is 10 ms in length. The chip rate in TD-SCDMA is 1.28 Mcps. The frame 502 has two 5 ms subframes 504, and each of the subframes 504 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 506, a guard period (GP) 508, and an uplink pilot time slot (UpPTS) 510 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 512 (each with a length of 352 chips) separated by a midamble 514 (with a length of 144 chips) and followed by a guard period (GP) 516 (with a length of 16 chips). The midamble 514 may be used for features, such as channel estimation, while the guard period 516 may be used to avoid inter-burst interference. Also transmitted in the data portion is some Layer 1 control information, including synchronization shift (SS) bits 518. Synchronization shift bits 518 only appear in the second part of the data portion. The synchronization shift bits 518 immediately following the midamble can indicate three cases: decrease shift, increase shift, or do nothing in the upload transmit timing. The positions of the synchronization shift bits 518 are not generally used during uplink communications.

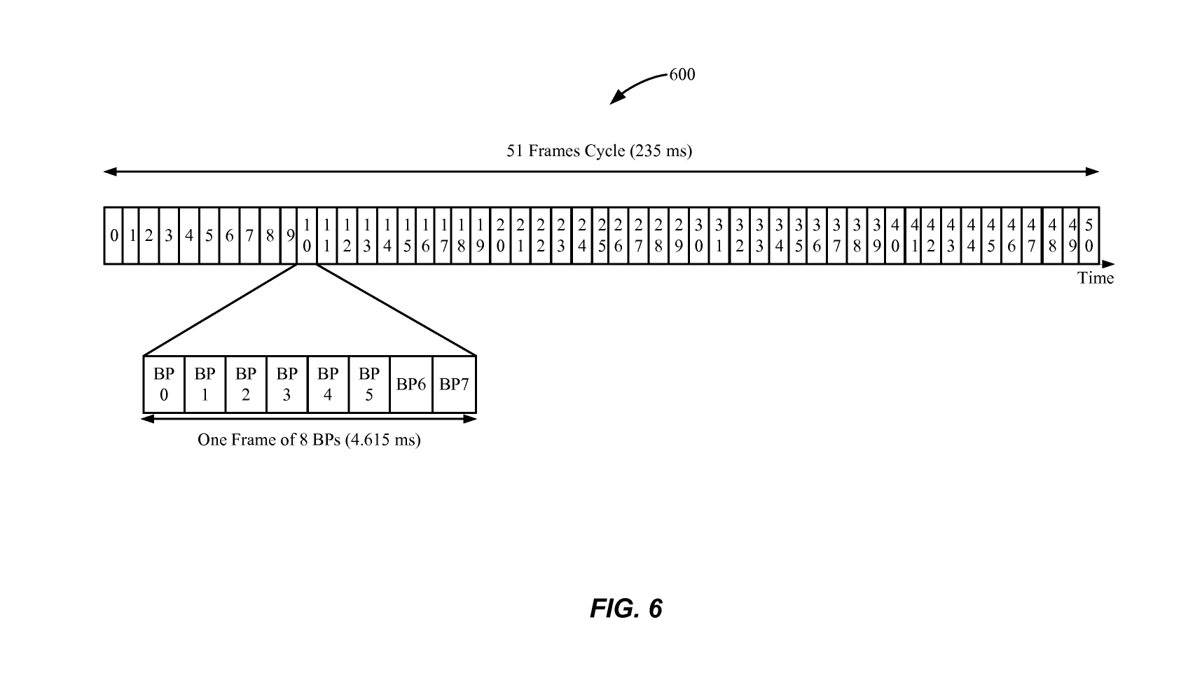

FIG. 6 is a block diagram illustrating an example of a GSM frame structure 600. The GSM frame structure 600 includes fifty-one frame cycles for a total duration of 235 ms. Each frame of the GSM frame structure 600 may have a frame length of 4.615 ms and may include eight burst periods, BP0-BP7.

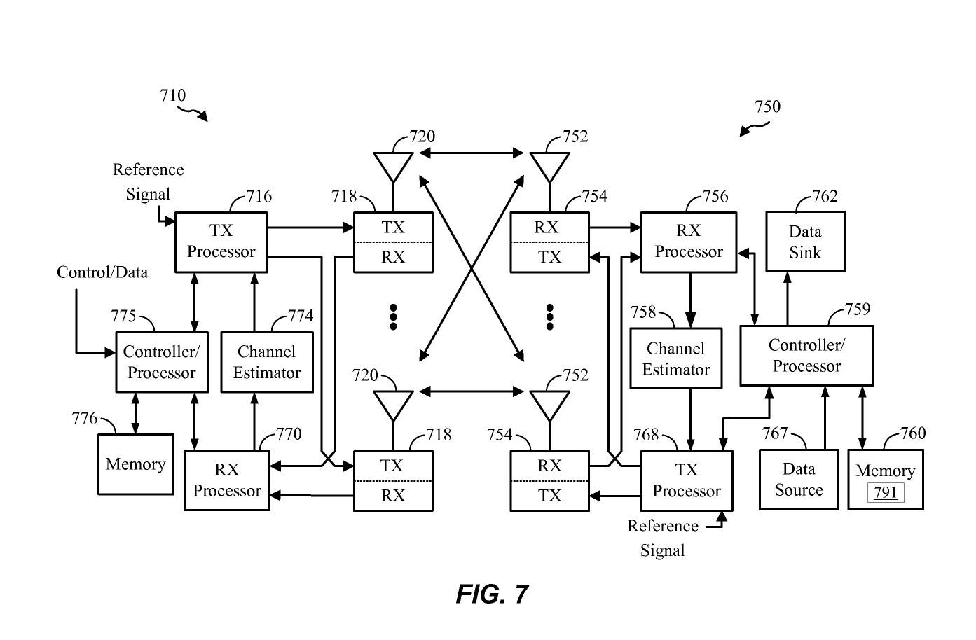

FIG. 7 is a block diagram of a base station (e.g., eNodeB or nodeB) 710 in communication with a UE 750 in an access network. In the downlink, upper layer packets from the core network are provided to a controller/processor 775. The controller/processor 775 implements the functionality of the L2 layer. In the downlink, the controller/processor 775 provides header compression, ciphering, packet segmentation and reordering, multiplexing between logical and transport channels, and radio resource allocations to the UE 750 based on various priority metrics. The controller/processor 775 is also responsible for HARQ operations, retransmission of lost packets, and signaling to the UE 750.

The TX processor 716 implements various signal processing functions for the L1 layer (i.e., physical layer). The signal processing functions includes coding and interleaving to facilitate forward error correction (FEC) at the UE 750 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 774 may be used to determine the coding and modulation scheme, as well as for spatial processing. The channel estimate may be derived from a reference signal and/or channel condition feedback transmitted by the UE 750. Each spatial stream is then provided to a different antenna 720 via a separate transmitter (TX) 718. Each transmitter (TX) 718 modulates an RF carrier with a respective spatial stream for transmission.

At the UE 750, each receiver (RX) 754 receives a signal through its respective antenna 752. Each receiver (RX) 754 recovers information modulated onto an RF carrier and provides the information to the receiver (RX) processor 756. The RX processor 756 implements various signal processing functions of the L1 layer. The RX processor 756 performs spatial processing on the information to recover any spatial streams destined for the UE 750. If multiple spatial streams are destined for the UE 750, they may be combined by the RX processor 756 into a single OFDM symbol stream. The RX processor 756 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the base station 710. These soft decisions may be based on channel estimates computed by the channel estimator 758. The soft decisions are then decoded and deinterleaved to recover the data and control signals that were originally transmitted by the base station 710 on the physical channel. The data and control signals are then provided to the controller/processor 759.

The controller/processor 759 implements the L2 layer. The controller/processor 759 can be associated with a memory 760 that stores program codes and data. The memory 760 may be referred to as a computer-readable medium. In the uplink, the controller/processor 759 provides demultiplexing between transport and logical channels, packet reassembly, deciphering, header decompression, control signal processing to recover upper layer packets from the core network. The upper layer packets are then provided to a data sink 762, which represents all the protocol layers above the L2 layer. Various control signals may also be provided to the data sink 762 for L3 processing. The controller/processor 759 is also responsible for error detection using an acknowledgement (ACK) and/or negative acknowledgement (NACK) protocol to support HARQ operations.

In the uplink, a data source 767 is used to provide upper layer packets to the controller/processor 759. The data source 767 represents all protocol layers above the L2 layer. Similar to the functionality described in connection with the downlink transmission by the base station 710, the controller/processor 759 implements the L2 layer for the user plane and the control plane by providing header compression, ciphering, packet segmentation and reordering, and multiplexing between logical and transport channels based on radio resource allocations by the base station 710. The controller/processor 759 is also responsible for HARQ operations, retransmission of lost packets, and signaling to the base station 710.

Channel estimates derived by a channel estimator 758 from a reference signal or feedback transmitted by the base station 710 may be used by the TX processor 768 to select the appropriate coding and modulation schemes, and to facilitate spatial processing. The spatial streams generated by the TX processor 768 are provided to different antenna 752 via separate transmitters (TX) 754. Each transmitter (TX) 754 modulates an RF carrier with a respective spatial stream for transmission.

The uplink transmission is processed at the base station 710 in a manner similar to that described in connection with the receiver function at the UE 750. Each receiver (RX) 718 receives a signal through its respective antenna 720. Each receiver (RX) 718 recovers information modulated onto an RF carrier and provides the information to a RX processor 770. The RX processor 770 may implement the L1 layer.

The controller/processor 775 implements the L2 layer. The controller/processors 775 and 759 can be associated with memories 776 and 760, respectively that store program codes and data. For example, the controller/processors 775 and 759 may provide various functions including timing, peripheral interfaces, voltage regulation, power management, and other control functions. The memories 776 and 760 may be referred to as a computer-readable media. For example, the memory 760 of the UE 750 may store a target cell selection module 791, which, when executed by the controller/processor 759, configures the UE 750 so that one subscription module performs cell selection based on location ID information.

In the uplink, the controller/processor 775 provides demultiplexing between transport and logical channels, packet reassembly, deciphering, header decompression, control signal processing to recover upper layer packets from the UE 750. Upper layer packets from the controller/processor 775 may be provided to the core network. The controller/processor 775 is also responsible for error detection using an ACK and/or NACK protocol to support HARQ operations.

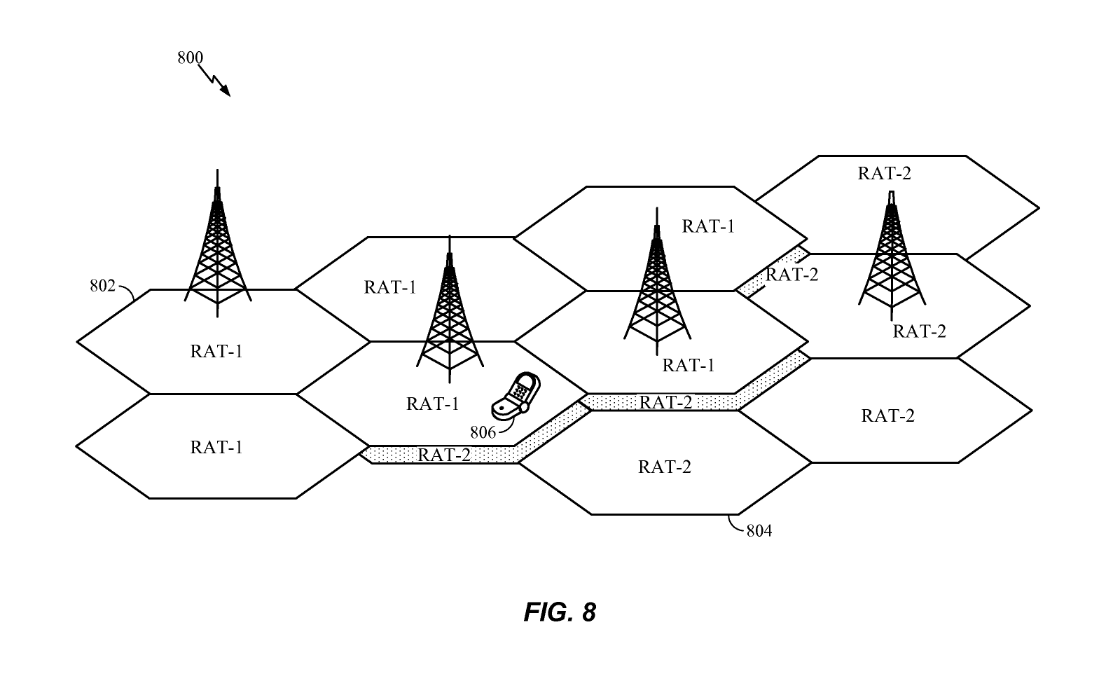

Some networks may be deployed with multiple radio access technologies. FIG. 8 illustrates a network utilizing multiple types of radio access technologies (RATs), such as but not limited to GSM (second generation (2G)), TD-SCDMA (third generation (3G)), LTE (fourth generation (4G)) and fifth generation (5G). Multiple RATs may be deployed in a network to increase capacity. Typically, 2G and 3G are configured with lower priority than 4G. Additionally, multiple frequencies within LTE (4G) may have equal or different priority configurations.

In one example, the geographical area 800 includes RAT-1 cells 802 and RAT-2 cells 804. In one example, the RAT-1 cells are 2G or 3G cells and the RAT-2 cells are LTE cells. However, those skilled in the art will appreciate that other types of radio access technologies may be utilized within the cells. A user equipment (UE) 806 may move from one cell, such as a RAT-1 cell 802, to another cell, such as a RAT-2 cell 804. The movement of the UE 806 may specify a handover or a cell reselection. The UE may also be redirected from a second RAT (RAT-2) to a different RAT (e.g., RAT-1) for a particular type of operation.

Redirection from one RAT to another RAT is commonly used to perform operations such as load balancing or circuit switched fallback from one RAT to another RAT. For example, one of the RATs may be long term evolution (LTE) while the other RAT may be universal mobile telecommunications system-frequency division duplexing (UMTS FDD), universal mobile telecommunications system-time division duplexing (UMTS TDD), or global system for mobile communications (GSM). In some aspects, the redirection may be from a frequency or cell of one RAT to a frequency or cell of the same RAT.

A handover or cell reselection may also be performed when there is a coverage hole or lack of coverage in one network or when there is traffic balancing between first RAT and the second RAT networks. As part of that handover or cell reselection process, while in a connected mode with a RAT-1 system, a UE may be specified to perform a measurement of a neighboring cell (such as a GSM cell). For example, the UE may measure the neighbor cells of a second network for signal strength, frequency channel, and base station identity code (BSIC). The UE may then connect to the strongest cell of the second network. Such measurement may be referred to as inter radio access technology (IRAT) measurement.

The UE may send the serving RAT-1 cell a measurement report indicating results of the IRAT measurements performed by the UE. The serving cell may then trigger a handover of the UE to a new cell in the other RAT, such as the RAT-2 cell, based on the measurement report. The measurement may include a serving cell signal strength, such as a received signal code power (RSCP) for a pilot channel (e.g., primary common control physical channel (PCCPCH)). The signal strength is compared to a serving system threshold. The serving system threshold can be indicated to the UE through dedicated radio resource control (RRC) signaling from the network. The measurement may also include a neighbor cell received signal strength indicator (RSSI). The neighbor cell signal strength can be compared with a neighbor system threshold. Before handover or cell reselection, in addition to the measurement processes, the base station IDs (e.g., BSICs) are confirmed and re-confirmed.

### Location ID Based Cell Selection Method for Circuit Switched Fall Back (CSFB) Calls

Circuit switched fall back (CSFB) is a feature that enables a multimode UE to receive circuit switched voice services from a 2G/3G network while camping on an LTE network that does not support voice service. A CSFB capable UE may initiate a mobile-originated (MO) or receive a mobile terminated (MT) circuit switched voice call while camping on an LTE network.

When the UE camps on an LTE cell and a 2G/3G cell at the same time, the UE may perform a combined registration with both networks. The UE may perform an attachment and tracking area update, and receive a registered tracking area code (TAC) for the LTE cell and a location area code (LAC) for the 2G/3G cell.

After the UE is redirected to the circuit switched RAT, the UE may choose as a default target cell, the cell corresponding to the strongest frequency on a frequency list included in the redirection command Redirection is typically performed blindly without the UE performing measurement and reporting the measurements on the circuit switched RAT. The blind redirection is intended to reduce latency of CSFB service by eliminating the time for measurement and measurement reporting on the circuit switched RAT.

Due to radio frequency (RF) variations, such as load changes or other conditions, it may not always be possible to have the LTE TAC and the 2G/3G LAC well aligned. If the LAC, as indicated by a collected SIB, is different from a registered LAC from the past combined registration, the UE may have to perform a Location Area Update (LAU) procedure before the circuit switched call setup procedure is initiated. The LAU procedure typically may take up to 2˜5 seconds or more based on the network loading. This may noticeably increase CSFB call setup latency, which may negatively impact user perception in a CSFB service.

A UE may collect SIBs in two phases in order for the UE to select a target cell to switch over to for the CSFB call. During the first phase, the UE may collect one by one short-period SIBs that indicate location IDs (e.g., LACs) for the top N cells corresponding to N strongest frequencies out of a list of potential frequencies included in the redirection command. For example, if N=3, based on the UE capabilities, the UE may collect for the top three cells' short-period SIBs, such as those SIBs indicating location ID, public land mobile network (PLMN) ID, minimal signal strength or quality requirement for the UE camping procedure, etc.

During the second phase, the UE may collect the mandatory long-period SIBs for one cell only, i.e., the selected target cell. The UE collects the long-period SIBs, which include information such as random access parameters, and downlink common channel configuration information, to enable the UE to switch over to the target cell. After switching to the target cell, the UE can set up the circuit switched call on the selected target cell.

The short-period SIBs are termed short-period SIBs because they have a shorter repeating period and thus take a shorter amount of time to collect and decode. A short-period SIB may indicate a cell location ID and network ID, among other information. Conversely, those SIBs with longer repeating periods are termed long-period SIBs. A long-period SIB may include parameters relating to the random access process, inter-frequency neighbor cells, intra-frequency neighbor cell and inter-RAT neighbor cells, among other information. The UE may collect the short-period SIBs in parallel using multiple receivers or diversity chains, or in series with a single receiver chain, based on the SIB arrival times. The SIB for the strongest cell may arrive earlier or later than the SIBs for non-strongest cells. After the UE decodes a synchronization channel and collects master information block (MIB) information, arriving times of the system information blocks (SIBs) become known to the UE.

According to aspects of the present disclosure, during the first phase, if the UE finds a cell with a location ID matching the location ID in a previous combined registration, and the synchronization channel quality of the cell is above a predefined threshold, the UE may select the cell as the target cell. The UE stops collecting short-period SIBs for other cells.

Otherwise, the UE may continue to collect short-period SIBs for the other top N cells or frequencies. If none of the location IDs for the top N cells meet the above conditions, the UE may select as the target cell the cell corresponding to the strongest frequency of the top N frequencies during a predetermined time period. The strongest cell may also be the target cell by default.

The predetermined time period may be determined based on a call type, a number of cells for which short-period SIBs are already collected and/or the time when a short-period SIB for the strongest cell is collected. For example, the call type can be a mobile originated call or a mobile terminated call. For a mobile terminated call, the time period may be set shorter than for a mobile originated call. In another example, if short-period SIBs are already collected for a large percentage of cells, the time period may be set shorter. As another example, if the short-period SIBs for the strongest cell are collected first, the time period may be shorter. Otherwise, if the short-period SIBs for the strongest cell are collected later, the time period may be longer. In one example, the predetermined time period or time window is dynamically adjusted based on one or more factors, such as those discussed above.

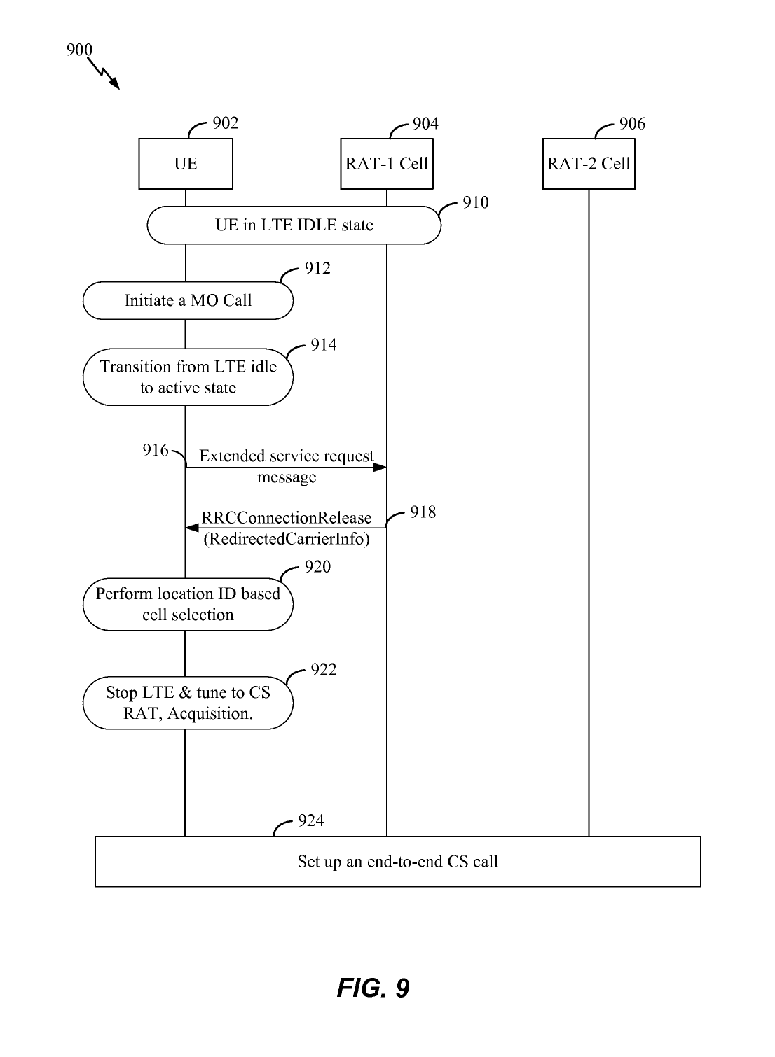

FIG. 9 shows a call flow diagram 900 conceptually illustrating an example process for location ID based cell selection for circuit switched fall back (CSFB) calls according to aspects of the present disclosure. The call flow diagram 900 illustrates the interactions among a UE 902, a RAT-1 base station 904 and a RAT-2 base station 906. In one aspect, the RAT-1 base station 904 may be an LTE or TD-LTE base station such as the eNodeB 106 of FIG. 1, nodeB 408 of FIG. 4 or base station 710 of FIG. 7. The RAT-2 base station 906 may be a 2G/3G RAT base station such as a GSM base station or a TD-SCDMA NodeB.

The UE 902 at time 910 may be camping on the RAT-1 base station 904. At time 912, the UE 902 may start a mobile originated (MO) voice call and as a result, the UE 902 may transition from the idle state to an active state, at time 914. At time 916, the UE 902 may send an extended service request to the current serving base station 904 to request a redirection to a RAT-2 cell 906 to service the mobile originated call that the UE 902 just initiated, because the RAT-1 base station 904 does not support voice calls. A CSFB indicator is included in the extended service request message. The redirection command is to redirect the UE 902 from one RAT to another RAT for a particular service and it is commonly used for services such as load balancing, circuit switched fallback (CSFB) from LTE to other RAT, among others.

In this example, at time 918, the UE 902 may receive a connection release message, such as radio resource control (RRC) connection release message, from the LTE base station 904. Included in the release message is a set of frequencies of RAT-2 for the UE 902 to select as a target cell.

At time 920, the UE 902 executes a location ID based cell selection method to select a target cell for the CSFB call while reducing CSFB call setup latency. Details of the location ID based cell selection method are provided below.

At time 922, the UE 902 may stop the first RAT, including stopping receiving information from the RAT-1 base station 904 and tune to the selected target cell of the second RAT. Once the UE 902 switches to the selected target cell, the UE 902 proceeds to setting up an end-to-end circuit switched (CS) call at time 924.

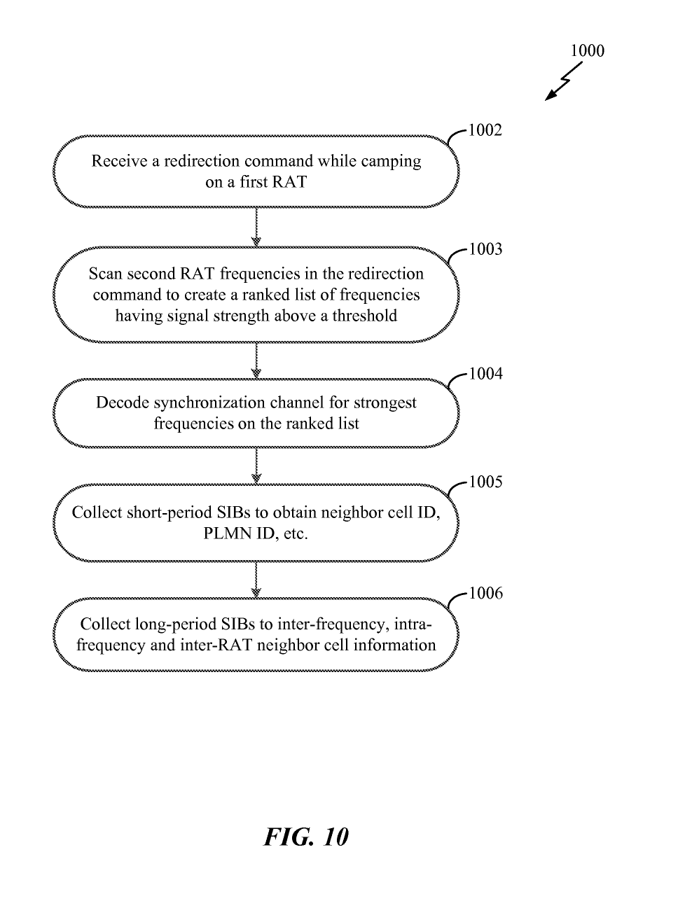

FIG. 10 is a flow diagram 1000 for obtaining information to perform an inter-RAT cell reselection or handover from a first RAT cell to a second RAT cell, according to aspects of the present disclosure.

At block 1002, the UE may receive a redirection command while camping on a first RAT cell, such as the eNodeB 106 of FIG. 1. This may happen when the UE initiates a mobile originated voice call or receives a mobile terminated voice call. The LTE network the UE is camping on does not support voice calls in this example and thus may redirect the UE to a circuit switched capable cell, such as a GSM cell or a TD-SCDMA cell, for providing the voice call service. In one aspect of the present disclosure, the redirection command is included in a connection release message, such as an LTE radio resource control (RRC) connection release message. Also included in the connection release message is a list of potential second RAT frequencies for selecting a target cell to switch to for the CSFB call.

At block 1003, the UE may scan all of the second RAT frequencies on the frequency list included in the redirection command and create a ranked frequency list. The UE ranks the frequencies, whose measured signal qualities are above a predetermined threshold, from strongest to weakest. The UE may then rank the frequencies or update a ranked frequency list, based on measured signal qualities. The measured signal qualities may include one or more of the following: received signal strength indicator (RSSI), received signal code power (RSCP), reference signal received power (RSRP), reference signal received quality (RSRQ), received signal strength indicator (RSSI), signal to noise ratio (SNR), and signal to interference plus noise ratio (SINR). In one aspect of the present disclosure, a cell corresponding to the strongest frequency on the ranked frequency list may be selected as the default target cell for the UE to switch to for the CSFB call.

In one example, the redirection command the UE receives in the LTE RRC connection release message includes a list of GSM absolute radio-frequency channel numbers (ARFCNs). In this GSM example, the UE performs a power scan for all of the GSM ARFCNs. The UE then ranks the GSM ARFCNs based on RSSI (received signal strength indicator) values for each RSSI that is above a predetermined threshold and determines a strongest GSM ARFCN.

At block 1004, for cells corresponding to the strongest frequencies on the ranked frequency list, the UE may decode synchronization channels. Examples of the synchronization channels are the GSM frequency correction channel (FCCH) and synchronization channel (SCH) carried in certain broadcast control channel (BCCH) time slots. After collecting and decoding the synchronization channels, the SIB arrival times for each cell corresponding to each frequency on the ranked frequency list become known to the UE.

At block 1005, the UE may collect and decode the short-period SIBs and obtain information such as public land mobile network (PLMN) ID, neighbor cell IDs and registration area IDs. The short-period SIBs are collected for frequencies on the ranked frequency list.

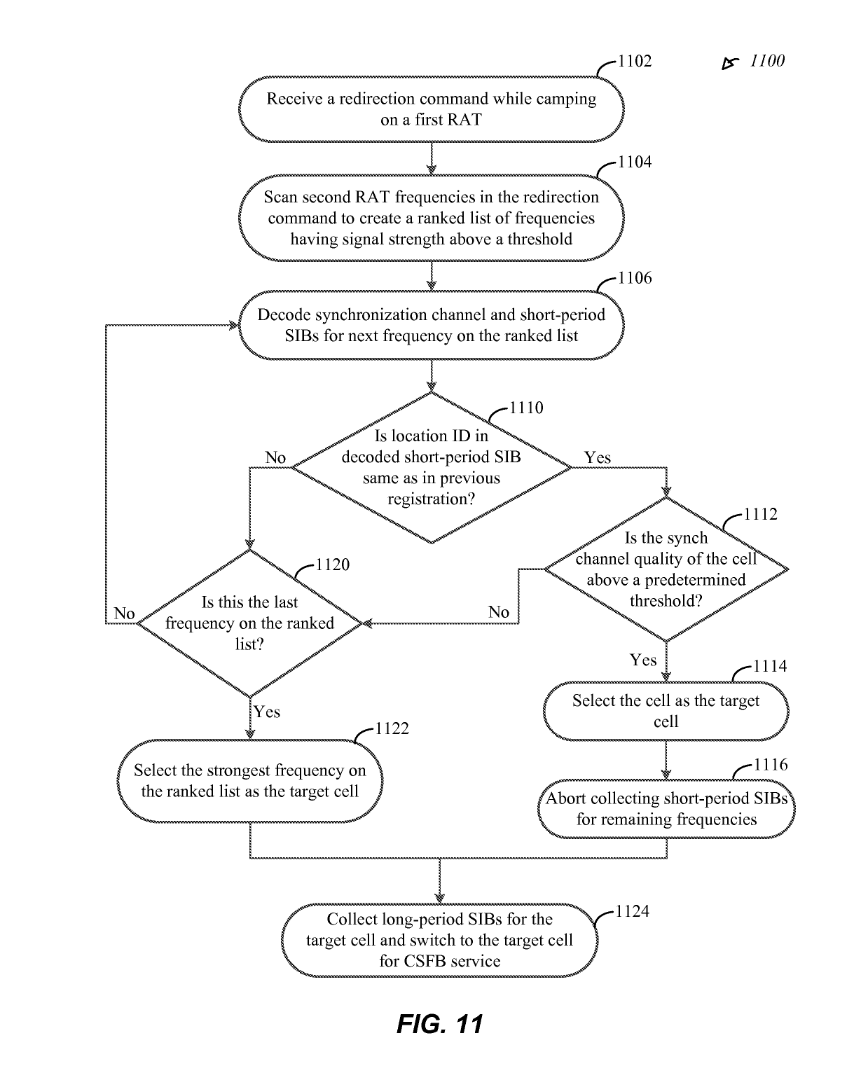

At block 1006, the UE may collect and decode the long-period SIBs and obtain random access channel (RACH) related information for reselection or handover to the selected target cell of the second RAT. The long-period SIB messages provide specific information about inter-RAT reselection, which the UE uses to perform reselection or handover from the current serving LTE cell to the selected target cell, in one example of the present disclosure. The arrival times of the long-period SIBs for the cells on the ranked frequency list are random. Further detail of long-period SIB collection is provided with respect to FIG. 11.

FIG. 11 shows a flow diagram 1100 illustrating, as an example, a decision process at a UE for location ID based cell selection for circuit switched fall back calls according to aspects of the present disclosure. The flow diagram 1100 is for illustration purposes only and other alternative aspects of the decision process for the cell selection are certainly possible.

At block 1102, the UE may receive a redirection command while camping on a first RAT cell, such as an LTE cell. This may happen when the UE makes a mobile originated voice call or receives a mobile terminated voice call. The LTE network the UE is camping on may not support voice calls and may redirect the UE to a second RAT cell, such as a GSM cell or TD-SCDMA cell, for providing the voice call service. In one aspect of the present disclosure, the redirection command is included in an LTE connection release message, such as a radio resource control (RRC) connection release message. Additionally included in the connection release message is a list of the second RAT frequencies for selecting a target cell to switch to for the CSFB call.

At block 1104, the UE may scan all of the second RAT frequencies on the frequency list included in the redirection command and create a ranked frequency list. The frequency list is ranked according to signal strength of those frequencies when the signal strengths exceed a predetermined threshold.

In one example aspect of the present disclosure, the redirection command that the UE receives included in the LTE RRC connection release message includes a list of GSM absolute radio-frequency channel numbers (ARFCNs). The UE performs a power scan for all the GSM ARFCNs. The UE then ranks the GSM ARFCNs based on RSSI (received signal strength indicator) values for each RSSI that is above a predetermined threshold and determines a strongest GSM ARFCN.

At block 1106, for each cell on the ranked frequency list, the UE may collect and decode short-period system information blocks (SIBs) after decoding synchronization channels for each frequency. Examples of the synchronization channels are the GSM frequency correction channel (FCCH) and synchronization channel (SCH) carried in certain broadcast control channel (BCCH) time slots. After collecting and decoding the synchronization channels, the UE knows the SIB arrival times for the cell. After decoding the short-period SIBs, the UE knows the arrival time of the long-period SIBs for the cells on the ranked frequency list. Included in the short-period SIBs is the location information (e.g., location area code (LAC) information) of the cell.

In one aspect of the present disclosure, each location area of a public land mobile network (PLMN) has its own unique identifier, which is known as its location area identity (LAI). This LAI, a unique identifier, is used for location updating of mobile subscribers, among other purposes. The LAI may include a three decimal digit mobile country code (MCC), a two to three digit mobile network code (MNC) that identifies the GSM PLMN in that country, and a location area code (LAC) which is a 16 bit number thereby allowing 65536 location areas within one GSM PLMN.

At block 1110, the UE determines whether the location ID obtained for the cell is the same as the location ID in a previous combined registration. When the UE performs a combined attachment and tracking area update, or a combined registration, the UE is registered with both the first RAT, such as LTE network, and a second RAT, such as a 2G or 3G network. Once registered with the two networks, the UE may receive location IDs (e.g., a registered tracking area code (TAC) for the LTE network and a location area code (LAC) for a GSM network.)

If the decoded location ID for the cell matches the location ID in a previous registration, the UE, at block 1112, may further determine whether the decoded synchronization channel signal quality is above a predetermined threshold. The synchronization channel signal quality is an indicator of the corresponding cell signal quality. The synchronization channel quality threshold may be determined based on the receiver capabilities of the UE. For example, if the UE receiver quality is high, the threshold may be set relatively lower, because the UE may accommodate a low quality channel for the CSFB call. Conversely, the threshold may be set higher to compensate for the low quality of the UE receiver.

At block 1114, if the synchronization channel quality is above the threshold, the UE may select the corresponding cell as the target cell in place of the default target cell corresponding to the strongest frequency on the ranked frequency list. At block 1116, the UE may abort collecting short-period SIBs for remaining frequencies on the ranked frequency list to reduce the call setup latency.

At block 1124, as part of a handover to a second RAT network, once the target cell is determined, the UE may proceed to collecting long-period SIBs for the selected target cell to gather information for a random access procedure for switching to the target cell for the CSFB call. This location ID based cell selection may avoid a location area update procedure if the location ID of the target cell matches the location ID in a previous combined registration. The process therefore reduces the call setup time for the CSFB call.

If the location ID indicated in the decoded short-period SIB does not match the location ID in the previous combined registration at block 1110 or the synchronization channel quality is not above the predetermined threshold at block 1112, the UE, at block 1120, further determines whether the ranked frequency list has been exhausted. If not, the UE returns to block 1106 and decodes synchronization channels and collects short-period SIBs for the next frequency on the ranked frequency list.

If the ranked frequency list has been exhausted, it may mean that none of the cells on the ranked frequency list has a location ID matching the location ID in a previous combined registration with a synchronization channel signal quality above the predetermined threshold. Then, at block 1122, the UE may select the cell with the strongest frequency on the ranked frequency list as the target cell. In another aspect of the present disclosure, the cell corresponding to the strongest frequency is selected as the default target cell, and the UE at block 1122 may affirm the default target cell selection. At block 1124, the UE may then proceed to collecting and decoding the long-period SIBs for the target cell and switching to the target cell for the CSFB service, as described earlier.

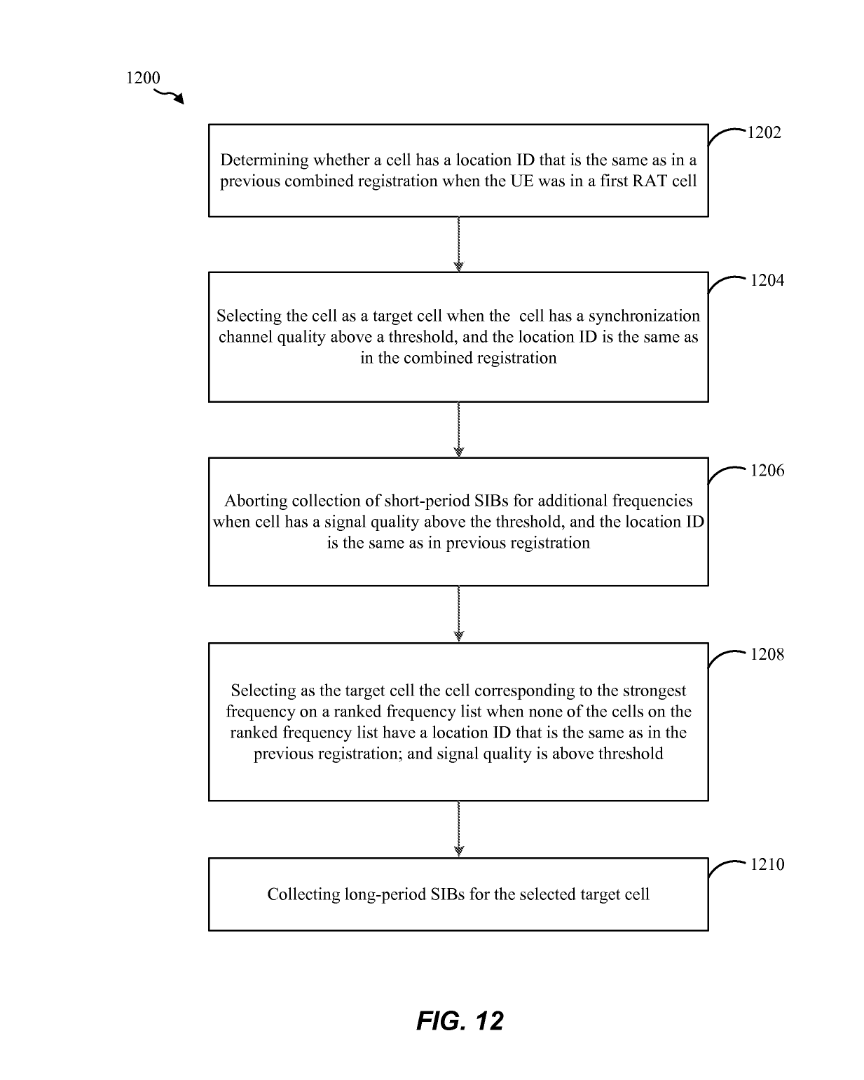

FIG. 12 is a flow diagram illustrating a method 1200 for location ID based cell selection for CSFB calls at a UE, according to aspects of the present disclosure. At block 1202, the UE determines whether a cell has a location ID that is the same as a previously registered location ID when the UE was in a first RAT cell. More specifically, the UE may determine whether the cell corresponding to a frequency on a ranked frequency list of a second RAT has a location ID matching the location ID of a previous combined registration. The combined registration may include the first RAT cell information and the second RAT cell information.

In one aspect of the present disclosure, the UE may be redirected to a 2G/3G network for a CSFB call while the UE is in an LTE cell. When the UE camps on two networks of two different RATs, the UE may perform a combined registration with both networks. In this case, the UE may perform a combined registration with both the LTE network and the 2G/3G network.

At block 1204, the UE may select the cell as the target cell when the cell has a synchronization channel quality above a predetermined threshold, and the location ID has a match. This allows the UE to use the location ID information from the previous combined registration and bypass a time-consuming Location Area Update (LAU) (or Tracking Area Update) procedure. This may also allow the UE to save battery power.

In one aspect of the present disclosure, the UE may already know the synchronization channel signal quality when the UE decodes the synchronization channel to obtain SIB arrival times. In general, the synchronization channel quality may indicate the signal quality of the cell. Checking the synchronization channel quality helps ensure that the cell signal quality is above a threshold for supporting a voice call.

At block 1206, the UE may abort collection of short-period SIBs for additional frequencies when the synchronization channel of the cell has a signal quality above the predetermined threshold, and the location ID of the cell matches the location ID in a previous combined registration. This may allow the UE to further conserve battery power.

Collecting short-period SIBs for each additional frequency may take place while the UE checks additional frequencies on the ranked frequency list for a location ID match with the previous combined registration. The UE may collect short-period SIBs in parallel if there are multiple receivers available at the UE. The UE may also collect SIBs in series based on the arrival times of the SIBs, if only a single receiver is available.

At block 1208, the UE may select as the target cell the cell corresponding to the strongest frequency on the ranked frequency list when none of the cells on the ranked frequency list has a location ID that matches that in a previous combined registration and a signal quality above the predetermined threshold. In one aspect of the present disclosure, the default choice of the target cell is the cell corresponding to the strongest cell on the ranked frequency list and the UE affirms the default target cell.

At block 1210, the UE proceeds to collecting long-period SIBs for the selected target cell. At this point, the UE already selected a target cell, either via location ID-based cell selection or the default target cell. Then the UE may collect and decode long period SIBs of the target cell to obtain information for switching to the target cell. In one aspect of the present disclosure, collecting the long-period SIBs for the target cell may include collecting at least the SIBs to gather information for inter-RAT reselection. Collecting the long-period SIBs for the new target cell may also include checking the long-period SIBs already collected up to this point, because it is possible that the long-period SIBs for the selected target cell have already been collected while looking for a location ID match for the frequencies on the ranked frequency list.

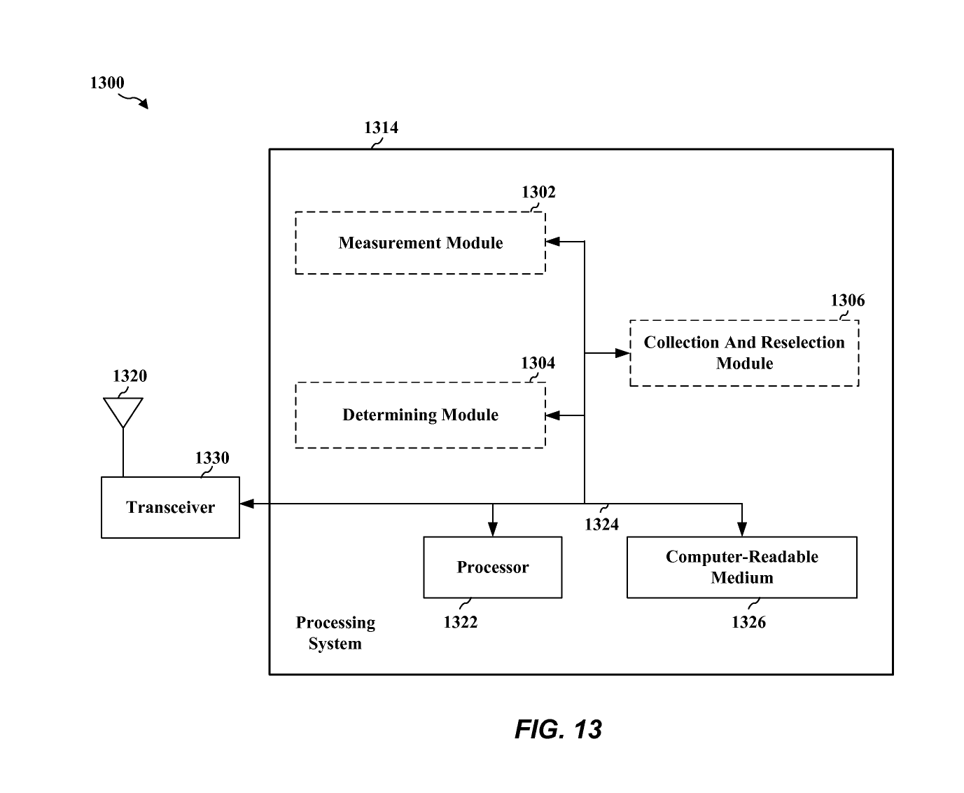

FIG. 13 is a block diagram illustrating an example of a hardware implementation for an apparatus 1300 employing a processing system 1314 with different modules/means/components for cell selection for CSFB calls in an example apparatus according to one aspect of the present disclosure. The processing system 1314 may be implemented with a bus architecture, represented generally by the bus 1324. The bus 1324 may include any number of interconnecting buses and bridges depending on the specific application of the processing system 1314 and the overall design constraints. The bus 1324 links together various circuits including one or more processors and/or hardware modules, represented by the processor 1322, the modules 1302, 1304, 1306, and the non-transitory computer-readable medium 1326. The bus 1324 may also link various other circuits such as timing sources, peripherals, voltage regulators, and power management circuits, which are well known in the art, and therefore, will not be described any further.

The apparatus includes a processing system 1314 coupled to a transceiver 1330. The transceiver 1330 is coupled to one or more antennas 1320. The transceiver 1330 enables communicating with various other apparatus over a transmission medium. The processing system 1314 includes a processor 1322 coupled to a non-transitory computer-readable medium 1326. The processor 1322 is responsible for general processing, including the execution of software stored on the computer-readable medium 1326. The software, when executed by the processor 1322, causes the processing system 1314 to perform the various functions described for any particular apparatus. The computer-readable medium 1326 may also be used for storing data that is manipulated by the processor 1322 when executing software.

The processing system 1314 includes a measurement module 1302 for measuring signal qualities of cells included in a connection release message received at the UE. The processing system 1314 also includes a determining module 1304 for determining a target cell based on location ID, e.g., location area code (LAC). The processing system 1314 may also include a collection module and reselection module 1306 for collecting long-period SIBs, and enabling the UE to switch from the current cell to the selected target cell. The modules 1302, 1304 and 1306 may be software modules running in the processor 1322, resident/stored in the computer-readable medium 1326, one or more hardware modules coupled to the processor 1322, or some combination thereof. The processing system 1314 may be a component of the UE 750 of FIG. 7 and may include the memory 760, and/or the controller/processor.

In one configuration, an apparatus such as a UE 750 of FIG. 7 is configured for wireless communication including means for determining a target cell based on location ID for a circuit switched fallback (CSFB) service from a first RAT to a second RAT. In one aspect, the determining means may be the controller/processor 759, the memory 760, measurement module 1302, determining module 1304, and/or the processing system 1314 configured to perform the functions recited by the determining means. In another aspect, the aforementioned means may be a module or any apparatus configured to perform the functions recited by the selecting means.

The UE 750 is also configured to include means for selecting a target cell. In one aspect, the selecting means may include the antennas 752, the receiver 354, the channel estimator 758, the receive processor 756, the controller/processor 759, the memory 760, the measurement module 1302, the determining module 1304, the reselection module 1306, and/or the processing system 1314 configured to perform the functions recited by the selecting means. In one configuration, the means and functions correspond to the aforementioned structures. In another aspect, the aforementioned means may be a module or any apparatus configured to perform the functions recited by the selecting means.

The UE 750 is also configured to include means for collecting short-period and long-period SIBs for the target cell. In one aspect, the collecting means may include the antennas 752, the receiver 754, the receive processor 756, the controller/processor 759, the memory 760, the reselection module 1306, and/or the processing system 1314 configured to perform the functions recited by the collecting means. In one configuration, the means and functions correspond to the aforementioned structures. In another aspect, the aforementioned means may be a module or any apparatus configured to perform the functions recited by the collecting means.

Several aspects of a telecommunications system has been presented with reference to LTE (in FDD, TDD, or both modes), 2G/3G RATs such as GSM, TD-SCDMA and CDMA2000, and evolution-data optimized (EV-DO). As those skilled in the art will readily appreciate, various aspects described throughout this disclosure may be extended to other telecommunication systems, network architectures and communication standards, including those with high throughput and low latency such as 4G systems, 5G systems and beyond. By way of example, various aspects may be extended to other systems such as LTE-advanced (LTE-A), W-CDMA, high speed downlink packet access (HSDPA), high speed uplink packet access (HSUPA), high speed packet access plus (HSPA+) and TD-CDMA. Various aspects may also be extended to systems employing ultra mobile broadband (UMB), IEEE 802.11 (Wi-Fi), IEEE 802.16 (WiMAX), IEEE 802.20, ultra-wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

It is also to be understood that the term “signal quality” is non-limiting. Signal quality is intended to cover any type of signal metric such as received signal code power (RSCP), reference signal received power (RSRP), reference signal received quality (RSRQ), received signal strength indicator (RSSI), signal to noise ratio (SNR), signal to interference plus noise ratio (SINR), etc.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication at a user equipment (UE), comprising:
determining whether a second radio access technology (RAT) cell corresponding to a frequency on a ranked frequency list of a second radio access technology (RAT) has a location ID indicated in a decoded short-period system information block (SIB) that matches a location ID from a previous combined registration of a first RAT and the second RAT when the UE was in a first RAT cell;
selecting the second RAT cell as a target cell when the second RAT cell has a synchronization channel signal quality above a threshold and the location ID matches a location ID from the combined registration; and
collecting a long-period SIB for the target cell.

2. The method of claim 1, further comprising aborting collection of short-period SIBs for additional frequencies on the ranked frequency list of the second RAT when the second RAT cell has a signal quality above the threshold, and the location ID matches.

3. The method of claim 1, further comprising selecting as the target cell a strongest cell corresponding to a strongest frequency on the ranked frequency list when no cell corresponding to the frequencies on the ranked list during a predetermined time period has a location ID matching the location ID from the combined registration, in which the predetermined time period is determined based at least in part on one of a call type, a number of cells for which short-period SIBs are already collected and a time spent to collect a short-period SIB for the strongest cell.

4. The method of claim 1 further comprising collecting short-period SIBs for multiple cells corresponding to multiple frequencies on the ranked frequency list with multiple receivers in parallel.

5. The method of claim 1 further comprising collecting short-period SIBs for multiple cells corresponding to multiple frequencies on the ranked frequency list with a single receiver in series based on short-period SIB arrival times indicated by synchronization channel decoding results.

6. The method of claim 1, in which the threshold is determined based at least in part on receiver capabilities of the UE.

7. An apparatus for wireless communication at a user equipment (UE), comprising:
a memory; and
at least one processor coupled to the memory and configured:
to determine whether a second radio access technology (RAT) cell corresponding to a frequency on a ranked frequency list of a second radio access technology (RAT) has a location ID indicated in a decoded short-period system information block (SIB) that matches a location ID from a previous combined registration of a first RAT and the second RAT when the UE was in a first RAT cell;
to select the second RAT cell as a target cell when the second RAT cell has a synchronization channel signal quality above a threshold and the location ID matches a location ID from the combined registration; and
to collect a long-period SIB for the target cell.

8. The apparatus of claim 7, in which the at least one processor is further configured to abort collection of short-period SIBs for additional frequencies on the ranked frequency list of the second RAT when the second RAT cell has a signal quality above the threshold, and the location ID matches.

9. The apparatus of claim 7, in which the at least one processor is further configured to select as the target cell a strongest cell corresponding to a strongest frequency on the ranked frequency list when no cell corresponding to the frequencies on the ranked list during a predetermined time period has a location ID matching the location ID from the combined registration, in which the predetermined time period is determined based at least on one of a call type, a number of cells for which short-period SIBs are already collected and a time spent to collect a short-period SIB for the strongest cell.

10. The apparatus of claim 7, in which the at least one processor is further configured to collect short-period SIBs for multiple cells corresponding to multiple frequencies on the ranked frequency list with multiple receivers in parallel.

11. The apparatus of claim 7, in which the at least one processor is further configured to collect short-period SIBs for multiple cells corresponding to multiple frequencies on the ranked frequency list with a single receiver in series based on short-period SIB arrival times indicated by synchronization channel decoding results.

12. The apparatus of claim 7, in which the threshold is determined based at least in part on receiver capabilities of the UE.

13. An apparatus for wireless communication at a user equipment (UE), comprising:
means for determining whether a second radio access technology (RAT) cell corresponding to a frequency on a ranked frequency list of a second radio access technology (RAT) has a location ID indicated in a decoded short-period system information block (SIB) that matches a location ID from a previous combined registration of a first RAT and the second RAT when the UE was in a first RAT cell;
means for selecting the second RAT cell as a target cell when the second RAT cell has a synchronization channel signal quality above a threshold and the location ID matches a location ID from the combined registration; and
means for collecting a long-period SIB for the target cell.

14. The apparatus of claim 13, further comprising means for aborting collection of short-period SIBs for additional frequencies on the ranked frequency list of the second RAT when the second RAT cell has a signal quality above the threshold, and the location ID matches.

15. The apparatus of claim 13, further comprising means for selecting as the target cell a strongest cell corresponding to a strongest frequency on the ranked frequency list when no cell corresponding to the frequencies on the ranked list during a predetermined time period has a location ID matching the location ID from the combined registration, in which the predetermined time period is determined based at least on one of a call type, a number of cells for which short-period SIBs are already collected and a time spent to collect a short-period SIB for the strongest cell.

16. The apparatus of claim 13, further comprising means for collecting short-period SIBs for multiple cells corresponding to multiple frequencies on the ranked frequency list with multiple receivers in parallel.

17. The apparatus of claim 13, further comprising means for collecting short-period SIBs for multiple cells corresponding to multiple frequencies on the ranked frequency list with a single receiver in series based on short-period SIB arrival times indicated by synchronization channel decoding results.

18. The apparatus of claim 13, in which the threshold is determined based at least in part on receiver capabilities of the UE.

19. An computer program product for wireless communication at a user equipment (UE), comprising:
a non-transitory computer-readable medium having encoded thereon program code, the program code comprising:
program code to determine whether a second radio access technology (RAT) cell corresponding to a frequency on a ranked frequency list of a second radio access technology (RAT) has a location ID indicated in a decoded short-period system information block (SIB) that matches a location ID from a previous combined registration of a first RAT and the second RAT when the UE was in a first RAT cell;
program code to select the second RAT cell as a target cell when the second RAT cell has a synchronization channel signal quality above a threshold and the location ID matches a location ID from the combined registration; and
program code to collect a long-period SIB for the target cell.

20. The computer program product of claim 19, further comprising program code to abort collection of short-period SIBs for additional frequencies on the ranked frequency list of the second RAT when the second RAT cell has a signal quality above the threshold, and the location ID matches.

21. The computer program product of claim 19, further comprising program code to select as the target cell a strongest cell corresponding to a strongest frequency on the ranked frequency list when no cell corresponding to the frequencies on the ranked list during a predetermined time period has a location ID matching the location ID from the combined registration, in which the predetermined time period is determined based at least on one of a call type, a number of cells for which short-period SIBs are already collected and a time spent to collect a short-period SIB for the strongest cell.

22. The computer program product of claim 19, further comprising program code to collect short-period SIBs for multiple cells corresponding to multiple frequencies on the ranked frequency list with multiple receivers in parallel.

23. The computer program product of claim 19, further comprising program code to collect short-period SIBs for multiple cells corresponding to multiple frequencies on the ranked frequency list with a single receiver in series based on short-period SIB arrival times indicated by synchronization channel decoding results.

24. The computer program product of claim 19, in which the threshold is determined based at least in part on receiver capabilities of the UE.
